(19) United States
(12) Patent Application Publication
(10) Pub. No.: US 2017/0083044 A1
(43) Pub. Date: Mar. 23, 2017

(54) TRANSPARENT DISPLAY DEVICE

(71) Applicant: EverDisplay Optronics (Shanghai) Limited, Shanghai City (CN)

(72) Inventors: Jr-Hong CHEN, Shanghai City (CN); Chien-Er HUANG, Shanghai City (CN)

(73) Assignee: EverDisplay Optronics (Shanghai) Limited, Shanghai City (CN)

(21) Appl. No.: 15/083,509

(22) Filed: Mar. 29, 2016

(30) Foreign Application Priority Data
Sep. 18, 2015 (CN) 201510595574.2

(51) Int. Cl. G06F 1/16; H04B 1/3827; G06F 3/01

(52) U.S. Cl. CPC G06F 1/1601; G06F 3/017; H04B 1/3833; G06F 2203/04804

(57) ABSTRACT

The present disclosure relates to a transparent display device, including a handheld housing defining an operation plane, which faces an operator, of the transparent display device; wherein the operation plane includes: a light-transmitting display region arranged in the operation plane, wherein a display module is provided in the light-transmitting display region and has a transmittance greater than or equal to 40%; and an opaque region arranged in the operation plane, wherein the opaque region is connected with the light-transmitting display region and a processor is provided in the opaque region for providing display signals to the display module; wherein an area of the light-transmitting display region is 0.85 to 0.9 of a whole area of the operation plane.

### CROSS-REFERENCE TO RELATED APPLICATIONS

This application claims priority to Chinese Patent Application No. 201510595574.2, filed Sep. 18, 2015, the entire contents of which are incorporated herein by reference.

### TECHNICAL FIELD

The present disclosure generally relates to an electronic device having a transparent display apparatus.

### BACKGROUND

The emerging of touch electronic devices such as smart phones on the market enables operating manners of electronic devices to change from physical keys to full touch screen operations. Generally, a touch screen occupies a relatively large area of an electronic device.

At present, many device makers seek to arrive at a “transparent display” effect of touch screens for the purpose of providing visual beauty. However, due to limitations in configuration of device structures, the transparent display of touch screens is only a concept and no actual products and implementable technical solutions for the transparent display are available on the market.

### SUMMARY

Aiming at the above and/or other problems in related arts, the present disclosure provides a transparent display device, including:

a handheld housing defining an operation plane, which faces an operator, of the transparent display device;

wherein the operation plane includes:

a light-transmitting display region arranged in the operation plane, wherein a display module is provided in the light-transmitting display region and has a transmittance greater than or equal to 40%; and

an opaque region arranged in the operation plane, wherein the opaque region is connected with the light-transmitting display region and a processor is provided in the opaque region for providing display signals to the display module;

wherein an area of the light-transmitting display region is 0.85 to 0.9 of a whole area of the operation plane.

According to an embodiment, the display module is an active matrix organic light emitting diode (AMOLED) module or a liquid crystal display (LCD) module.

According to an embodiment, the display module is a flexible AMOLED module.

According to an embodiment, a battery unit, a circuit board and at least one subscriber identity module (SIM) card tray are further provided in the opaque region, and the processor is disposed on the circuit board which couples the battery unit with the display module, the processor and the SIM card tray.

According to an embodiment, an opening corresponding to the SIM card tray is provided at a side of the handheld housing.

According to an embodiment, the transparent display device includes at least one receiver which is coupled with the circuit board.

According to an embodiment, the at least one receiver is embedded into the handheld housing.

According to an embodiment, a solar module, which has a transmittance greater than or equal to 40% and electrically connected with the battery unit, is further provided in the light-transmitting display region.

According to an embodiment, the transparent display device is a mobile phone.

The transparent display device provided in the present disclosure can realize a transparent display effect to provide visual beauty, and can also meet the arrangement requirements of other portions of the transparent display device. Thus, the transparent display device can be implemented as an actual product and meanwhile satisfy visual and application requirements.

### BRIEF DESCRIPTION OF THE DRAWINGS

FIG. 1 is a schematic diagram showing a transparent display device according to an embodiment of the present disclosure; and

FIG. 2 is a schematic diagram showing a structure of an opaque region A2 in FIG. 1.

### DETAILED DESCRIPTION

Now, exemplary implementations will be described more comprehensively with reference to the accompanying drawings. However, the exemplary implementations may be carried out in various manners, and shall not be interpreted as being limited to the implementations set forth herein; instead, providing these implementations will make the present disclosure more comprehensive and complete and will fully convey the conception of the exemplary implementations to the ordinary skills in this art. Throughout the drawings, the like reference numbers refer to the same or the like structures, and repeated descriptions will be omitted.

The features, structures or characteristics described herein may be combined in one or more embodiments in any suitable manner. In the following descriptions, many specific details are provided to facilitate sufficient understanding of the embodiments of the present disclosure. However, one of ordinary skills in this art will appreciate that the technical solutions in the present disclosure may be practiced without one or more of the specific details, or by employing other methods, components, materials and so on. In other conditions, well-known structures, materials or operations are not shown or described in detail so as to avoid confusion of respective aspects of the present disclosure.

The drawings of the present disclosure are only for illustrating relative position relationships and electrical connections, and the thicknesses of some portions are shown exaggeratedly to facilitate understanding, and however the thicknesses in the drawings do not indicate proportional relations and real thicknesses.

### First Embodiment

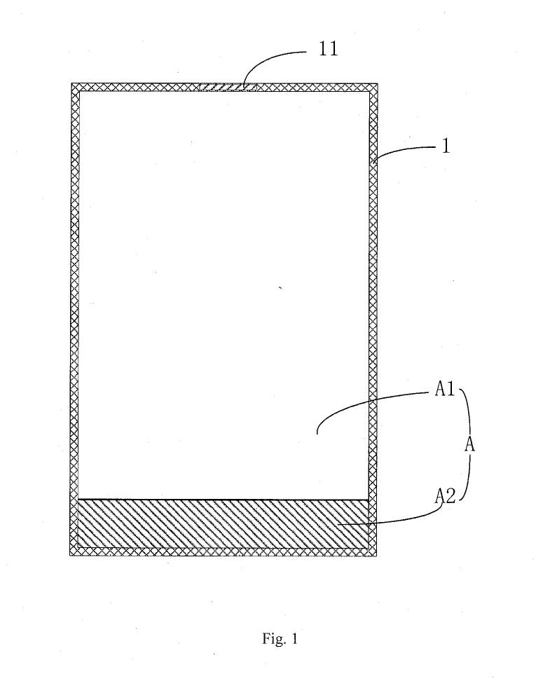

FIG. 1 is a schematic diagram showing a transparent display device according to a first embodiment of the present disclosure. The transparent display device includes a handheld housing 1 defining an operation plane A, which faces an operator (or a user), of the transparent display device.

The operation plane A includes a light-transmitting display region A1 and an opaque region A2 which are arranged in the operation plane A.

A display module (not shown) is provided in the light-transmitting display region A1. The display module has a transmittance greater than or equal to 40%. The area of the light-transmitting display region A1 is 0.85 to 0.90 of the whole area of the operation plane A.

The opaque region A2 is connected with the light-transmitting display region A1. A processor (not shown) for providing display signals to the above display module is provided in the opaque region A2.

Optionally, in the embodiment, the display module may be an active matrix organic light emitting diode (AMOLED) display or a liquid crystal display (LCD) module. For example, the display module may be a flexible AMOLED module.

In the embodiment, a solar module (not shown) may be further provided in the light-transmitting display region A1, and the solar module may have a transmittance greater than or equal to 40%.

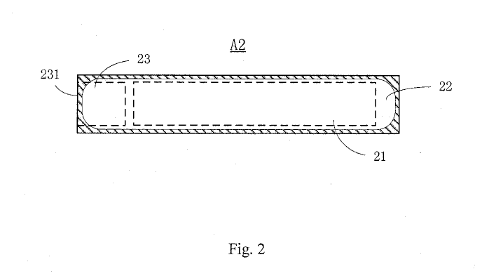

Optionally, as shown in FIG. 2, in the embodiment, a battery unit 21, a circuit board 22 and at least one SIM card tray 23 may be provided in the opaque region A2.

The above-mentioned processor may be disposed on the circuit board 22 which then may couple the battery unit 21 with the above-mentioned display module, the processor and the SIM card tray 23.

The above solar module may be electrically connected with the battery unit 21.

As shown in FIG. 2, an opening 231 corresponding to the SIM card tray 23 may be provided at a side of the handheld housing 1.

In the embodiment, the transparent display device may further include at least one receiver 11 which is coupled with the circuit board 22. In the embodiment, the receiver 11 may be embedded into the handheld housing 1, as shown in FIG. 1. Optionally, if the handheld housing 1 is substantially of a shape of rectangle, the receiver 11 may be disposed at the upper or lower side, or the left or right side of the handheld housing 1 (depending on the position of the operator), for example, at the upper or right side, and as another example, at the relatively short side.

The transparent display device in the embodiment may be a mobile phone, for example, a smart phone having a touch screen.

It shall be appreciated that although the present disclosure is described according to different embodiments, each embodiment does not include only one independent technical solution, such descriptions are only for convenience in illustrating, and one of ordinary skill in this art may take the specification as a whole to properly combine the technical solutions in respective embodiments so as to form other implementations which are conceivable by one of ordinary skill in this art.

The above detailed descriptions relate to some possible implementations of the present disclosure, and however they are not for limiting the protection scope of the present disclosure, and any equivalent implementations or modifications without departing the spirit of the present disclosure shall fall within the protection scope of the present disclosure.

What is claimed is:

1. A transparent display device, comprising:
a handheld housing defining an operation plane of the transparent display device;
wherein the operation plane comprises:
a light-transmitting display region arranged in the operation plane, wherein a display module is provided in the light-transmitting display region and has a transmittance greater than or equal to 40%; and
an opaque region arranged in the operation plane, wherein the opaque region is connected with the light-transmitting display region and a processor is provided in the opaque region for providing display signals to the display module;
wherein an area of the light-transmitting display region is 0.85 to 0.9 of a whole area of the operation plane.

2. The transparent display device according to claim 1, wherein the display module is an active matrix organic light emitting diode (AMOLED) module or a liquid crystal display (LCD) module.

3. The transparent display device according to claim 2, wherein the display module is a flexible AMOLED module.

4. The transparent display device according to claim 1, wherein a battery unit, a circuit board and at least one subscriber identity module (SIM) card tray are further provided in the opaque region, and the processor is disposed on the circuit board which couples the battery unit with the display module, the processor and the SIM card tray.

5. The transparent display device according to claim 4, wherein an opening corresponding to the SIM card tray is provided at a side of the handheld housing.

6. The transparent display device according to claim 4, wherein the transparent display device comprises at least one receiver which is coupled with the circuit board.

7. The transparent display device according to claim 6, wherein the at least one receiver is embedded into the handheld housing.

8. The transparent display device according to claim 4, wherein a solar module, which has a transmittance greater than or equal to 40% and electrically connected with the battery unit, is further provided in the light-transmitting display region.

9. The transparent display device according to claim 1, wherein the transparent display device is a mobile phone.

10. The transparent display device according to claim 4, wherein the transparent display device is a mobile phone.

11. The transparent display device according to claim 5, wherein the transparent display device is a mobile phone.

12. The transparent display device according to claim 6, wherein the transparent display device is a mobile phone.

13. The transparent display device according to claim 7, wherein the transparent display device is a mobile phone.

14. The transparent display device according to claim 8, wherein the transparent display device is a mobile phone.
